(19) United States
(12) Patent Application Publication
(10) Pub. No.: US 2023/0275344 A1
(43) Pub. Date: Aug. 31, 2023

(54) ANTENNA STRUCTURE AND WEARABLE DEVICE HAVING SAME

(71) Applicant: Chiun Mai Communication Systems, Inc., New Taipei (TW)

(72) Inventors: CHO-KANG HSU, New Taipei (TW); YI-CHIEH LEE, New Taipei (TW); JUNG-CHIN LIN, New Taipei (TW); CHANG-YI PENG, New Taipei (TW); HSIN-SHENG HUANG, New Taipei (TW)

(21) Appl. No.: 18/115,641

(22) Filed: Feb. 28, 2023

Related U.S. Application Data
(60) Provisional application No. 63/315,064, filed on Feb. 28, 2022.

(51) Int. Cl. H01Q 1/44; H01Q 1/27; H01Q 5/307

(52) U.S. Cl. CPC H01Q 1/44; H01Q 1/273; H01Q 5/307

(57) ABSTRACT

An antenna structure applied in a wearable device includes a ceramic layer, a plastic layer, a radiating portion, a feed portion; and a connecting portion. The ceramic layer includes a first surface and a second surface corresponding to each other. The plastic layer is connected to the second surface. The radiating portion is a predetermined metal pattern and arranged in the first surface. The connecting portion passes through the plastic layer and is electrically connected to the feed portion. The feed portion feeds an electrical current to the radiating portion to generate radiation signals in at least one radiation frequency band. A wearable device having the antenna structure is also provided.

### CROSS-REFERENCE TO RELATED APPLICATIONS

This application claims priority to U.S. Patent provisional Application No. 63/315,064 filed on Feb. 28, 2022, the contents of which are incorporated by reference herein.

### FIELD

The subject matter herein generally relates to an antenna structure and a wearable device having the antenna structure.

### BACKGROUND

With the advancement of wireless communication technology, wearable devices are now more multi-functional, smaller, lighter, faster transmitting, and higher efficiency. However, an antenna structure is complicated and occupies a large space in a wearable device, which makes miniaturization of the wearable device problematic. Sometimes it is needed to design metal logos arranged on a housing of the wearable device may affect a transmission characteristic of the antenna structure. Therefore, there is room for improvement within the art.

### BRIEF DESCRIPTION OF THE DRAWINGS

Implementations of the present disclosure will now be described, by way of example only, with reference to the attached figures.

FIG. 1 is a schematic diagram of a first embodiment of a wearable device including an antenna structure.

FIG. 2 is an explored diagram of the wearable device of FIG. 1 including the antenna structure.

FIG. 3 is a cross-sectional view of the wearable device of FIG. 1 including the antenna structure.

FIG. 4 is a cross-sectional view of the first embodiment of the wearable device of FIG. 1 including the antenna structure.

FIG. 5 is another cross-sectional view of the first embodiment of the wearable device of FIG. 1 including the antenna structure.

FIG. 6 is a return loss graph of the antenna structure of FIG. 2 applied in the wearable device.

FIG. 7 is a radiation efficiency graph of the antenna structure of FIG. 2 applied in the wearable device.

FIG. 8 is a schematic diagram of a second embodiment of a wearable device including an antenna structure.

FIG. 9 is an explored diagram of the wearable device of FIG. 8 including the antenna structure.

FIG. 10 is another explored diagram of the wearable device of FIG. 8 including the antenna structure.

FIG. 11 is a cross-sectional view of one embodiment of the wearable device of FIG. 8 including the antenna structure.

FIG. 12 is another cross-sectional view of another embodiment of the wearable device of FIG. 8 including the antenna structure.

FIG. 13 is a schematic diagram of one embodiment of a first radiating portion of the antenna structure of FIG. 9.

FIG. 14 is a schematic diagram of another embodiment of the first radiating portion of the antenna structure of FIG. 9.

FIG. 15 is a return loss graph of the antenna structure of FIG. 9 applied in the wearable device.

FIG. 16 is a radiation efficiency graph of the antenna structure of FIG. 9 applied in the wearable device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better show details and features of the present disclosure.

Several definitions that apply throughout this disclosure will now be presented.

The term “coupled” is defined as connected, whether directly or indirectly through intervening components, and is not necessarily limited to physical connections. The connection may be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but may have one or more deviations from a true cylinder. The term “comprising,” when utilized, means “including, but not necessarily limited to”; it specifically indicates open-ended inclusion or membership in the so-described combination, group, series, and the like.

The present disclosure is described in relation to an antenna structure and a wearable device having the same.

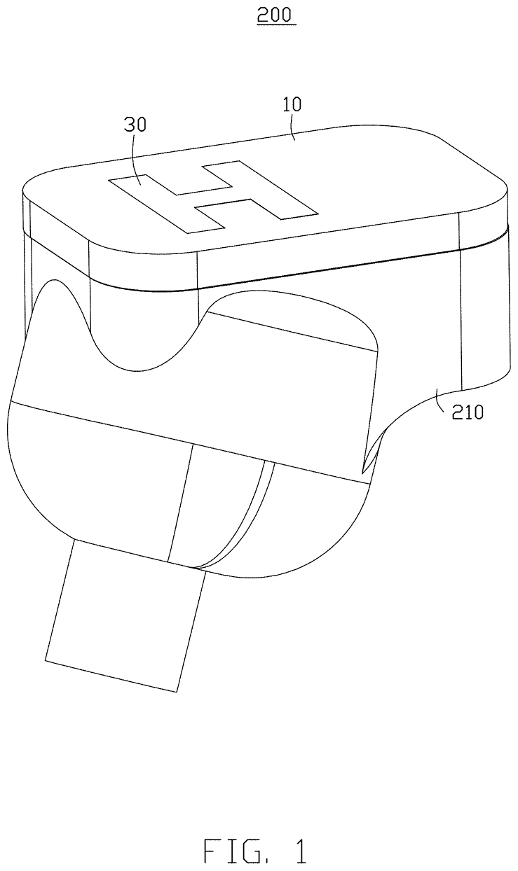

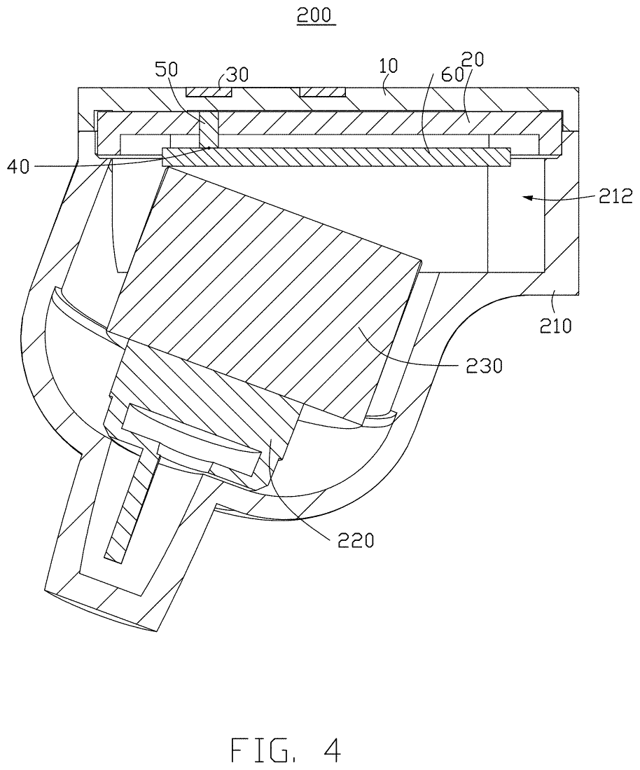

FIG. 1 and FIG. 4 illustrate a first embodiment of a wearable device 200 having an antenna structure 100. The antenna structure 100 may be applied in the wearable device 200, which may be for example, a headset, a headphone, an earphone, or a head-mounted telephone receiver. The antenna structure 100 may transmit and receive radio waves, to exchange radiation signals.

The wearable device 200 may be used in any of the following communication technologies: BLUETOOTH (BT) communication technology, global positioning system (GPS) communication technology, wireless fidelity (Wi-Fi) communication technology, global system for mobile communication (GSM) technology, wideband code division multiple access (WCDMA) communication technology, long term evolution (LTE) communication technology, 5G communication technology, SUB-6G communication technology, and any other future communication technologies.

Referring to FIGS. 1, 2, and 3, the wearable device 200 includes the antenna structure 100, a housing 210, a speaker 220, and a battery 230. The antenna structure 100, the speaker 220, and the battery 230 may be received in the housing 210.

The housing 210 is substantially hollow to form a receiving chamber 212. The housing 210 forms an opening 214 to connect the receiving chamber 212 and external of the housing 210. In at least one embodiment, an opening area of the opening 214 is greater than a cross-sectional opening area of the receiving chamber 212, so a peripheral wall of the opening 214 and a peripheral wall of the receiving chamber 212 may cooperatively form a stepped structure, a top surface of the peripheral wall of the receiving chamber 212 may form a supporting surface.

The antenna structure 100, the speaker 220, and the battery 230 may be orderly received in the receiving chamber 212. In at least one embodiment, the housing 210 may be made of plastic materials. It should be known that, according to appearance demands of the wearable device 200, the housing 210 may be made of other non-metal materials, such as glass, wood, ceramic, etc.

The antenna structure 100 includes a ceramic layer 10, a plastic layer 20, a radiating portion 30, a feed portion 40, a connecting portion 50, and a circuit board 60. The plastic layer 20 is mainly served as a carrier of the ceramic layer 10 and the radiating portion 30, the radiating portion connects the circuit board 60 by the connecting portion 50 passing through the plastic layer 20.

The ceramic layer 10 may be made of ceramic materials with predetermined dielectric constants. In at least one embodiment, a range of the predetermined dielectric constants of the ceramic layer 10 may be 10˜40.

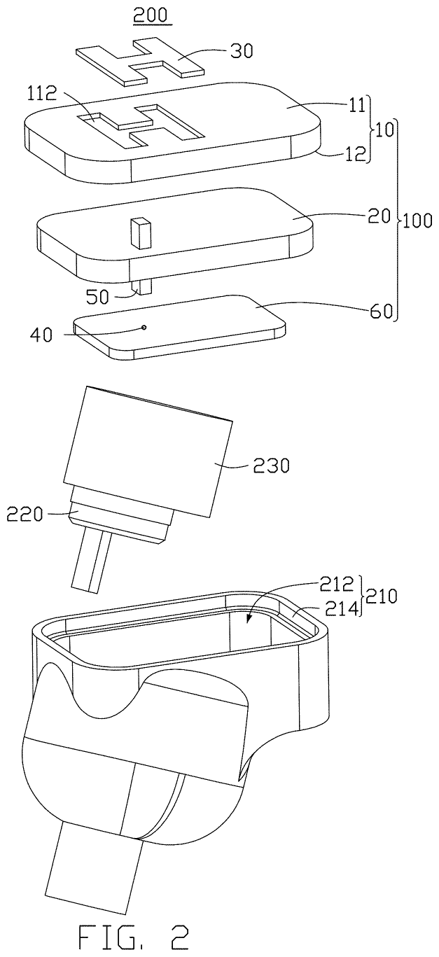

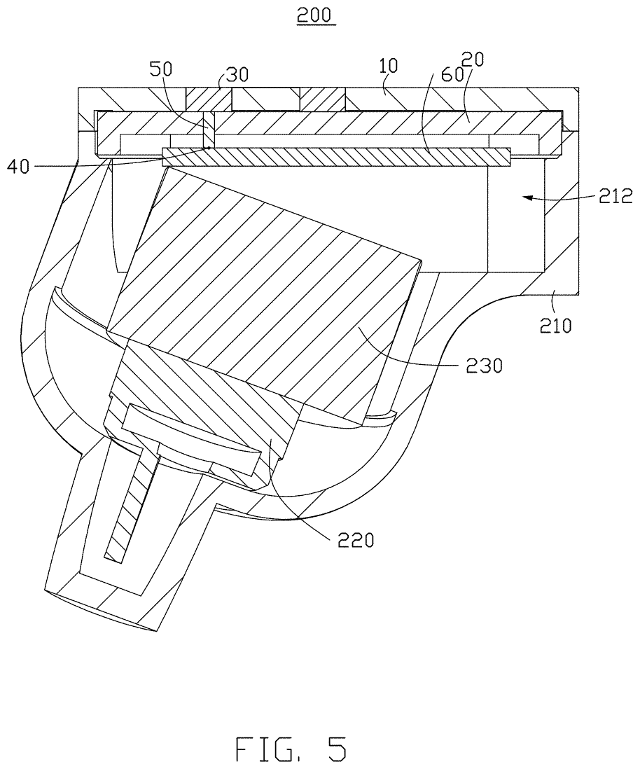

The ceramic layer 10 and the plastic layer 20 may be conjunctively mounted to the opening 214 of the housing 210, to close the receiving chamber 212. The ceramic layer 10 includes a first surface 11 and a second surface 12 corresponding to each other. The first surface 11 may be an appearance surface of the wearable device 200, that is, the first surface 11 may be an exterior surface of the wearable device 200, the second surface 12 may be an interior surface of the wearable device 200 facing the receiving chamber 212. As shown in FIG. 2, the first surface 11 defines a slot 112. The slot 112 is formed by inwardly recessing the first surface 11, that is, the slot 112 is exposed on the first surface 11. In one embodiment, referring to FIG. 5, the slot 112 is defined through the ceramic layer 10, that is, the slot 112 is defined through from the first surface 11 to the second surface 12.

The plastic layer 20 connects to the second surface 12 of the ceramic layer 10. The plastic layer 20 may be mounted to the opening 214 of the housing 210 and on the top surface of the peripheral wall of the receiving chamber 212, so the plastic layer 20 may be sealed to the opening 214 by the ceramic layer 10. The plastic layer 20 may serve as a carrier of the ceramic layer 10.

The radiating portion 30 may be a predetermined metal pattern. The radiating portion is arranged on the ceramic layer 10. In at least one embodiment, the radiating portion 30 may be arranged in the slot 2 and aligned with the first surface 11. In addition, the radiating portion 30 is exposed on the first surface 11, thus, the radiating portion 30 being the predetermined metal pattern is exposed from the appearance surface of the wearable device 200, to form a predetermined metal logo. It should be known that, the radiating portion 30 may be metal logo in other structure according to design demands, and exposed from the appearance surface of the wearable device 200, to form characteristic metal logos, so as to improve a peculiarity and an identifiability of the wearable device 200. In other embodiments, the radiating portion 30 may be arranged in the slot 112 of the ceramic layer 10 and slightly recessed from the first surface 11, the radiating portion 30 may be further pained by the predetermined materials to be aligned with the first surface 11, that is, the radiating portion 30 may be arranged in the ceramic layer 10. It should be known that, the predetermined materials may be transparent materials or high perspective materials, which makes the radiating portion 30 being the predetermined metal pattern can be visible from the appearance surface of the wearable device 200, to form the predetermined metal logo.

corresponding radiation paths. In other embodiments, the radiating portion 30 can be changed into any letter structures, letter shapes, typeface structures, strip structures, font shapes, pattern shapes, or pattern structures, which includes a plurality of radiating arms connected to each other, the radiating arms may form corresponding radiation paths.

The feed portion 40 may be an electrical feeding source or a feeding point on the circuit board 60 and configured to provide electrical current for the radiating portion 30.

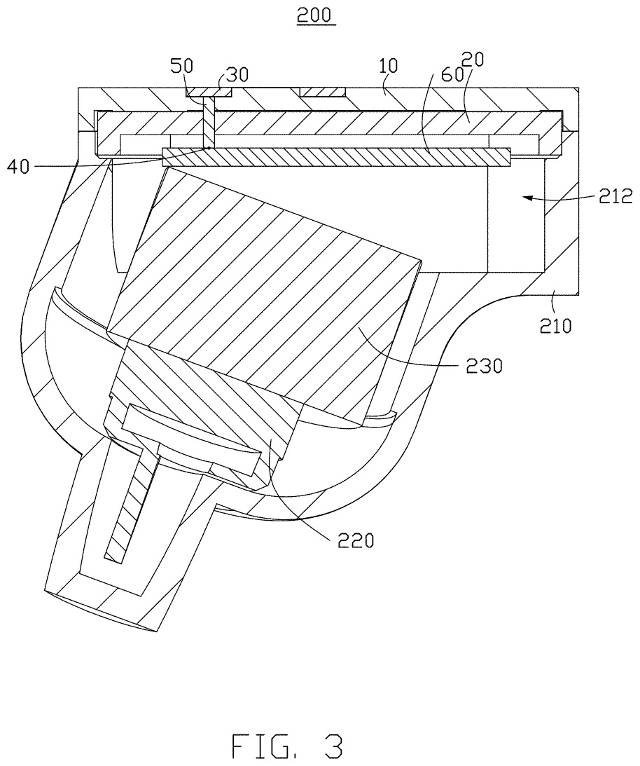

Referring to FIG. 3, the connecting portion 50 may pass through the plastic layer 20 and the ceramic layer 10, the connecting portion 50 electrically connects the radiating portion 30 and the feed portion 40. In at least one embodiment, the connecting portion 50 passes through the plastic layer 20 and passes from the second surface 12 to the slot 112, to electrically connect to the radiating portion 30 received in the slot 112. The connecting portion 50 may be made of metal conductive materials and configured to feed the electrical current from the feed portion 40 to the radiating portion 30. In at least one embodiment, the connecting portion 50 may be but is not limited to an elastic sheet, a microstrip line, a strip line, or a coaxial cable, etc. Referring to FIG. 4, in at least one embodiment, the connecting portion 50 passes through the plastic layer 20 and resists against the ceramic layer 10. Therefore, the connecting portion 50 is spaced apart from the radiating portion 30, so after the connecting portion 50 feeds in the electrical current, the electrical current can be coupled to the radiating portion 30 by the connecting portion 50. At this time, a cross-sectional area of the connecting portion 50 may be increased to increase a coupled effect between the connecting portion 50 and the radiating portion 30. Referring to FIG. 5, in other embodiments, the radiating portion 30 passes through the ceramic layer 10, the connecting portion 50 passes through the plastic layer 20 and resists against the radiating portion 30, so after the connecting portion 50 feeds in the electrical current, the electrical current can be conducted to the radiating portion 30 by the connecting portion 50.

The circuit board 60 is arranged apart from a side of the plastic layer 20 that away from the ceramic layer 10. The circuit board 60 further provides ground for the radiating portion 30. The circuit board 60 further arranges with a main circuit for processing signals.

In at least one embodiment, the antenna structure 100 may further include a matching circuit (not shown in the figures). In a first embodiment, the matching circuit may be arranged on a surface of the plastic layer 20 facing the ceramic layer 10. The main circuit of the circuit board 60 outputs signals passing through the connecting portion 50 and then the matching circuit, and finally conducts to the radiating portion 30. In a second embodiment, the matching circuit may be arranged on a surface of the plastic layer 20 facing the circuit board 60, the main circuit of the circuit board 60 outputs signals passing through the matching circuit, and further conducts to the radiating portion 30 by the connecting portion 50. In a third embodiment, the matching circuit may be arranged on the circuit board 60, signals outputted by the main circuit of the circuit board 60 may be conducted through the matching circuit, and further conducted to the radiating portion 30 by the connecting portion 50. The matching circuit electrically connects to the feed portion 40 and adjusts a radiating frequency band of the radiation signals generated by the radiating portion 30.

The speaker 220 and the battery 230 may be arranged on a side of the circuit board 60 away from the plastic layer 20. It can decrease affection to the radiation signals generated by the radiating portion 30 by the arrangement.

In at least one embodiment, when the feed portion 40 feeds an electrical current through the connecting portion 50 to the radiating portion 30, the electrical current finally flows to the radiating arms of the radiating portion 30. The radiating portion 30 and the ceramic layer 10 cooperatively form an antenna resonate radiating structure to excite a first working mode and generate a radiation signal in a first radiation frequency band. The radiating portion 30 and the ceramic layer 10 cooperatively form an antenna radiating portion to form a monopole antenna radiating portion. In at least one embodiment, the first working mode includes a Bluetooth and WiFi 2.4 GHz mode, the frequency of the first radiation frequency band includes 2400-2484 MHz.

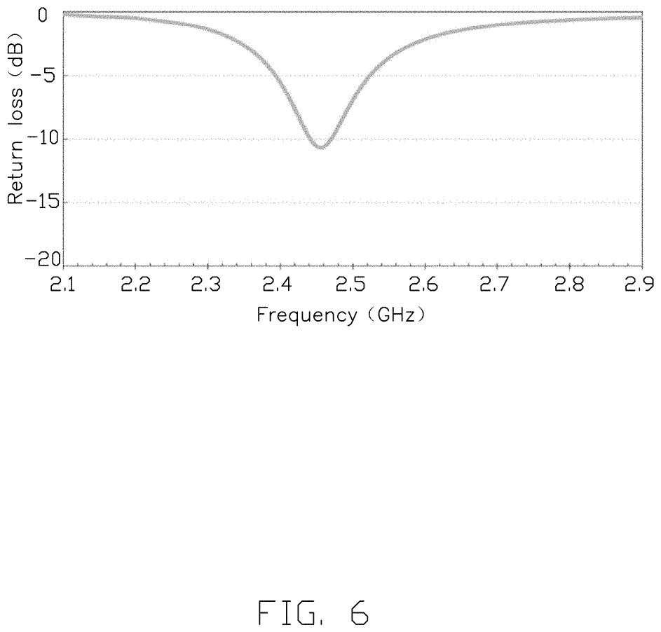

FIG. 6 is a return loss graph of the antenna structure 100. The curve shown in FIG. 6 shows return loss values when the antenna structure 100 applied in the wearable device 200. As shown in FIG. 6, it can be known that the working mode of the antenna structure 100 may cover the Bluetooth and WiFi 2.4 GHz mode, the frequency of the first radiation frequency band (2400-2484 MHz) of the antenna structure 100 may meet wireless communication requirements.

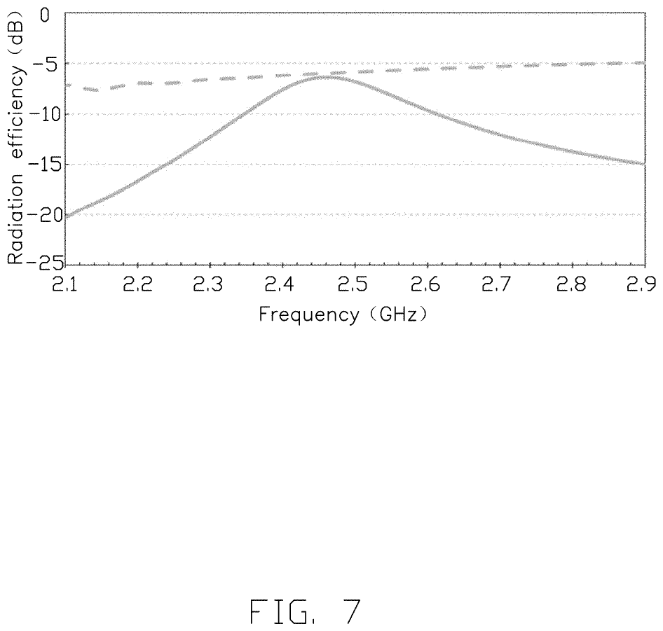

FIG. 7 is a radiation efficiency graph of the antenna structure 100. The curve shown in FIG. 7 shows radiation efficiencies when the antenna structure 100 applied in the wearable device 200. As shown in FIG. 7, it can be known that the antenna structure 100 has a good radiation characteristic in the frequency band of 2400-2484 MHz, which may meet wireless communication requirements.

The antenna structure 100 sets the radiating portion 30 on the appearance surface of the wearable device 200 to form the predetermined metal logo, which may improve a peculiarity and an identifiability of the wearable device 200. Meanwhile, the antenna structure 100 sets the radiating portion 30 in the ceramic layer 10 and uses the dielectric constants of the ceramic layer 10, to achieve the working frequency band of the antenna structure 100 and cover the frequency band of the Bluetooth and WiFi 2.4 GHz mode, which may improve frequency width of the antenna structure 100 and radiation efficiency of the antenna structure 100, achieving a great transmission characteristic of the wearable device 200.

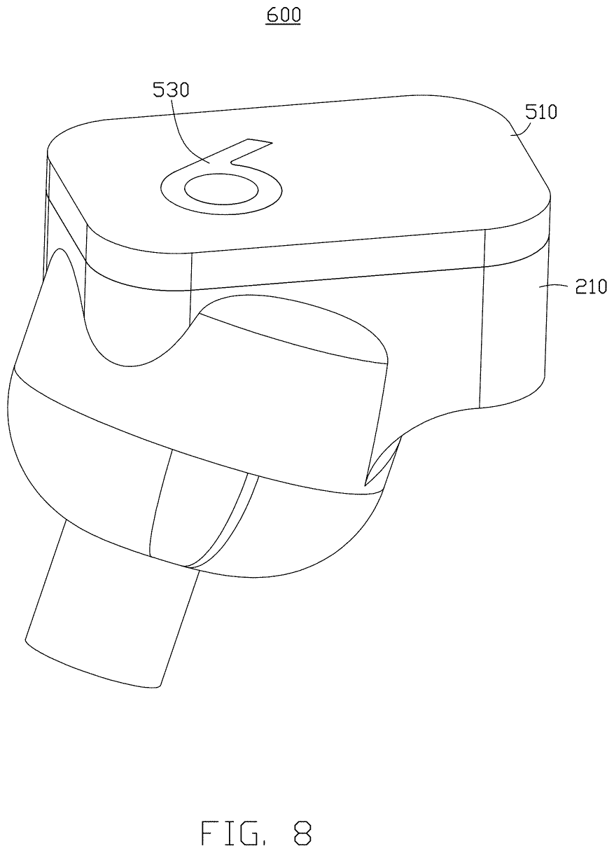

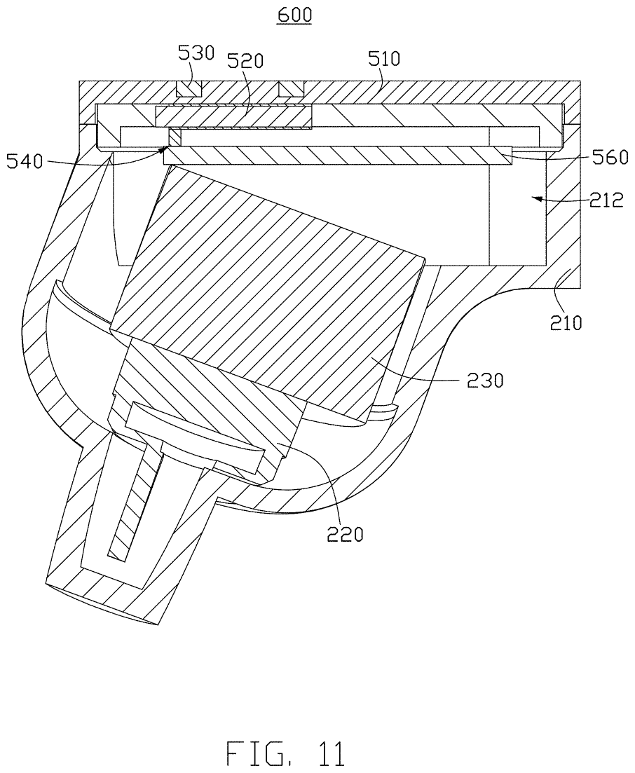

FIGS. 8 to 12 illustrate a second embodiment of a wearable device 600 having an antenna structure 500. The antenna structure 500 may be applied in the wearable device 600, which may be for example, a headset, a headphone, an earphone, or a head-mounted telephone receiver. The antenna structure 500 may transmit and receive radio waves, to exchange radiation signals.

The wearable device 600 may be used in any of the following communication technologies: BLUETOOTH (BT) communication technology, global positioning system (GPS) communication technology, wireless fidelity (Wi-Fi) communication technology, global system for mobile communication (GSM) technology, wideband code division multiple access (WCDMA) communication technology, long term evolution (LTE) communication technology, 5G communication technology, SUB-6G communication technology, and any other future communication technologies.

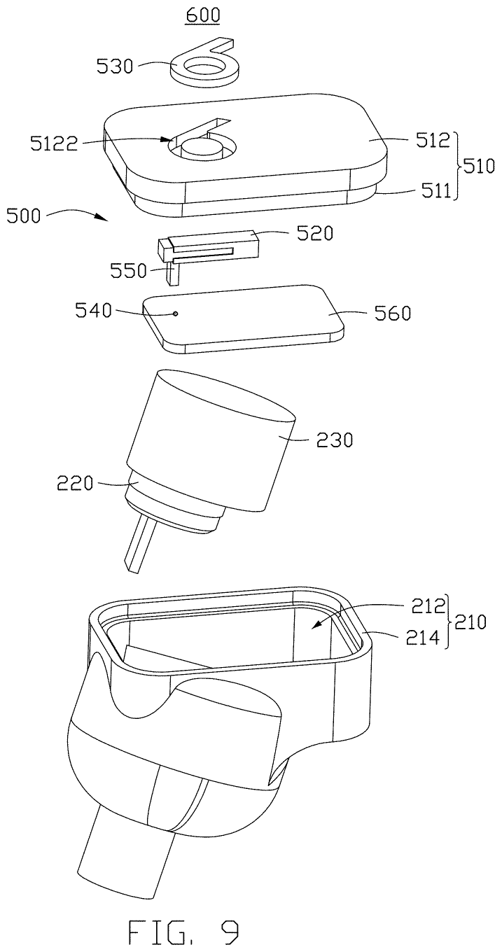

Referring to FIGS. 9, 10, 11, and 12, the wearable device 600 of the second embodiment is similar to the wearable device 200 of the first embodiment, which having similar elements. The wearable device 600 of the second embodiment includes the antenna structure 500, a housing 210, a speaker 220, and a battery 230. The antenna structure 500, the speaker 220, and the battery 230 may be received in the housing 210.

The housing 210 is substantially hollow to form a receiving chamber 212. The housing 210 forms an opening 214 to connect the receiving chamber 212 and external of the housing 210. In at least one embodiment, an opening area of the opening 214 is greater than a cross-sectional opening area of the receiving chamber 212, so a peripheral wall of the opening 214 and a peripheral wall of the receiving chamber 212 may cooperatively form a stepped structure, a top surface of the peripheral wall of the receiving chamber 212 may form a supporting surface.

The antenna structure 500, the speaker 220, and the battery 230 may be orderly received in the receiving chamber 212. In at least one embodiment, the housing 210 may be made of plastic materials. It should be known that, according to appearance demands of the wearable device 200, the housing 210 may be made of other non-metal materials, such as glass, wood, ceramic, etc.

The antenna structure 500 includes a plastic layer 510, a first radiating portion 520, a second radiating portion 530, a feed portion 540, a connecting portion 550, and a circuit board 560.

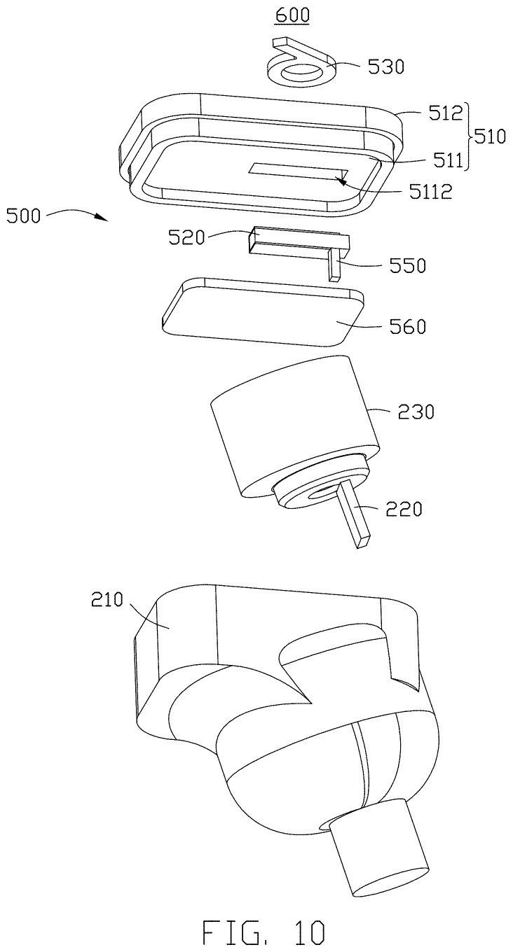

The plastic layer 510 may be mounted to the opening 214 of the housing 210, to close the receiving chamber 212. The plastic layer 510 includes a first surface 511 and a second surface 512 corresponding to each other. The second surface 512 may be an appearance surface of the wearable device 600, that is, the second surface 512 may be an exterior surface of the wearable device 600, the first surface 511 may be an interior surface of the wearable device 600 facing the receiving chamber 212. As shown in FIG. 10, the first surface 511 defines a first slot 5112. The first slot 5112 is formed by inwardly recessing the first surface 511, that is, the first slot 5112 is exposed on the first surface 511. In one embodiment, the structure of the first slot 5112 may suitably receive the first radiating portion 520. In at least one embodiment, the first radiating portion 520 can be changed into any letter structures, letter shapes, typeface structures, strip structures, font shapes, pattern shapes, or pattern structures. As shown in FIG. 9, the second surface 512 defines a second slot 5122, the second slot 5122 is formed by inwardly recessing the second surface 512. The structure of the second slot 5122 may suitably receive the second radiating portion 530. In at least one embodiment, the second radiating portion 530 can be changed into any letter structures, letter shapes, typeface structures, strip structures, font shapes, pattern shapes, or pattern structures.

In at least one embodiment, the second slot 5122 may not be communicated with the first slot 5112. The second slot 5122 is spaced apart from the first slot 5112 by a predetermined distance, so the first radiating portion 520 may be spaced apart from the second radiating portion 530 by the predetermined distance.

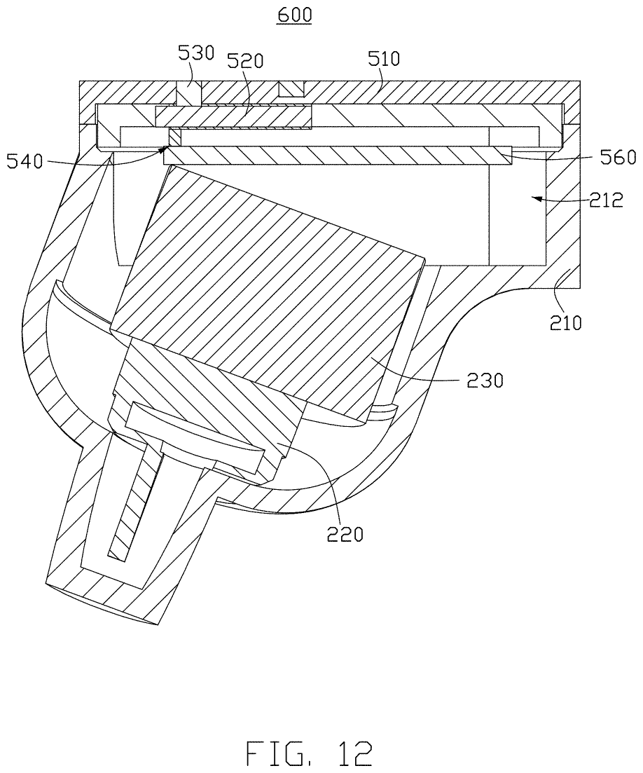

Referring to FIG. 12, in at least one embodiment, the second slot 5122 may be communicated with the first slot 5112, so the first radiating portion 520 may be contacted with the second radiating portion 530.

The first radiating portion 520 may be a ceramic antenna made of ceramic materials having predetermined dielectric constants. In at least one embodiment, a range of the predetermined dielectric constants of the ceramic materials may be 10˜40.

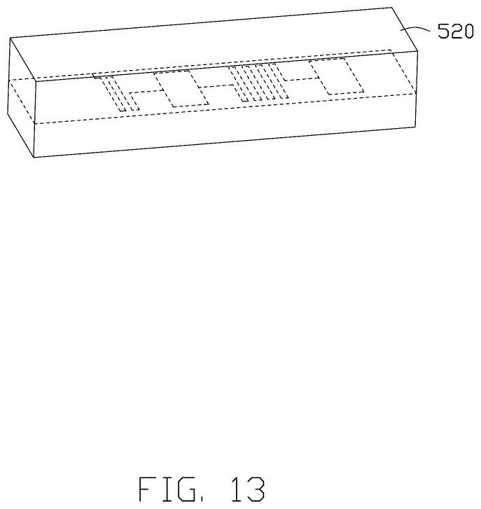

Referring to FIG. 13, in at least one embodiment, the first radiating portion 520 may be a ceramic antenna formed by a ceramic material external housing coating a metal material internal base.

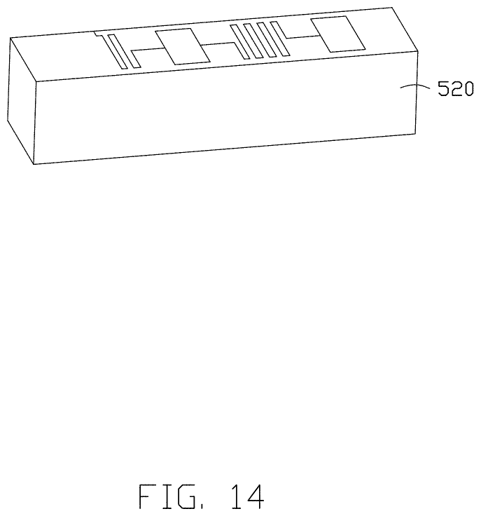

Referring to FIG. 14, in at least one embodiment, the first radiating portion 520 may be a ceramic antenna formed by sintering a ceramic material base with high temperature and molding a metal radiating portion on a surface of the sintered ceramic material base with a laser direct structuring (LDS) processing technology.

The first radiating portion 520 is arranged in the plastic layer 10. In at least one embodiment, the first radiating portion 520 may be arranged in the first slot 5112 of the plastic layer 10, the first radiating portion 520 is aligned with the first surface 511 and exposed on the first surface 511. In at least one embodiment, a structure of the first radiating portion 520 may be corresponding to a structure of the first slot 5112, so the first radiating portion 520 may be suitably received in the first slot 5112.

The second radiating portion 530 may be a predetermined metal pattern. The second radiating portion 530 is arranged on the plastic layer 10. In at least one embodiment, the second radiating portion 530 may be arranged in the second slot 5112 and aligned with the second surface 512. In addition, the second radiating portion 530 is exposed on the second surface 512, thus, the second radiating portion 530 being the predetermined metal pattern is exposed from the appearance surface of the wearable device 600, to form a predetermined metal logo. It should be known that, the second radiating portion 530 may be metal logo in other structure according to design demands, and exposed from the appearance surface of the wearable device 600, to form characteristic metal logos, so as to improve a peculiarity and an identifiability of the wearable device 600.

Referring to FIGS. 1 and 8, in at least one embodiment, the second radiating portion 530 may be substantially H-shaped (as shown in FIG. 1) or a digital 6-shaped (as shown in FIG. 8), has a plurality of radiating arms connected to each other, the radiating arms may form corresponding radiation paths. In other embodiments, the second radiating portion 530 may be any other English letter structures, typeface structures, strip structures, or pattern structures, which includes a plurality of radiating arms connected to each other, the radiating arms may form corresponding radiation paths.

The feed portion 540 may be an electrical feeding source or a feeding point on the circuit board 560 and configured to provide the electrical current for the first radiating portion 520.

The circuit board 560 is arranged apart from the first surface 511 of the plastic layer 510. The circuit board 560 further provides ground for the first radiating portion 530. The circuit board 560 further arranges with a main circuit for processing signals.

The connecting portion 550 may be electrically connected to the first radiating portion 520 and the feed portion 540. The connecting portion 550 may be made of metal conductive materials and configured to feed electrical current from the feed portion 540 to the first radiating portion 520. In at least one embodiment, the connecting portion 550 may be but is not limited to an elastic sheet, a microstrip line, a strip line, or a coaxial cable, etc.

In at least one embodiment, the antenna structure 500 may further include a matching circuit (not shown in the figures). In at least one embodiment, the matching circuit may be arranged on a surface of the circuit board 560 facing the first radiating portion 520. The main circuit of the circuit board 560 outputs signals passing through the matching circuit, and finally conducts to the first radiating portion 520. The matching circuit electrically connects to the feed portion 540 and adjusts a radiation frequency band of radiation signals generated by the first radiating portion 520 and the second radiating portion 530.

The speaker 220 and the battery 230 may be arranged on a side of the circuit board 560 away from the plastic layer 510. It can decrease affection to the radiation signals generated by the first radiating portion 520 and the second radiating portion 530 by the arrangement.

In at least one embodiment, when the feed portion 540 feeds an electrical current through the connecting portion 550 to the first radiating portion 520, the electrical current flows to the first radiating portion 520, then the electrical current is further coupled to and flows through the second radiating portion 530. The first radiating portion 520 and the second radiating portion 530 cooperatively form an antenna resonate radiating structure to excite a second working mode and generate a radiation signal in a second radiation frequency band. The first radiating portion 520 and the second radiating portion 530 cooperatively form an antenna radiating portion to form a monopole antenna radiating portion. In at least one embodiment, the second working mode includes a Bluetooth and WiFi 2.4 GHz mode, the frequency of the second radiation frequency band includes 2400-2484 MHz.

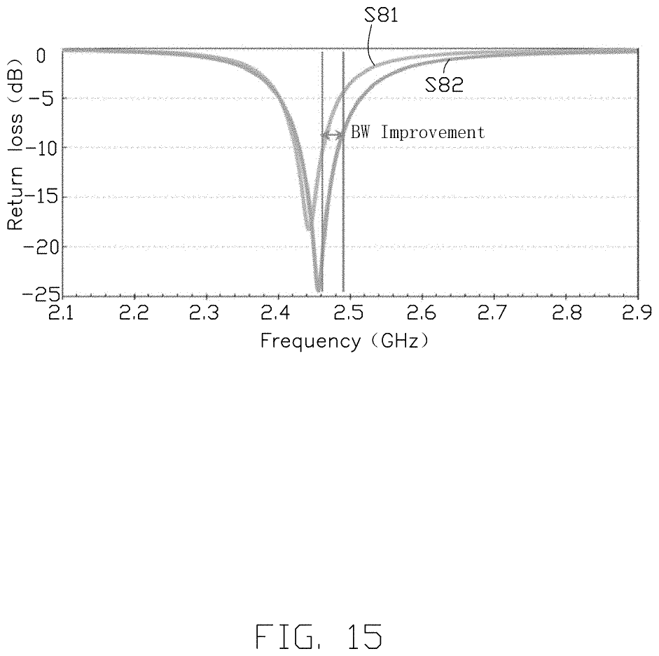

FIG. 15 is a return loss graph of the antenna structure 500. A curve S81 shows return loss values when the antenna structure 500 excluding the second radiating portion 530; a curve S82 shows return loss values when the antenna structure 500 including the second radiating portion 530. As shown in FIG. 15, it can be know that when the antenna structure 500 includes the second radiating portion 530, and the second radiating portion 530 takes part in radiation signals, the second radiating portion 530 may effectively improve radiation frequency bandwidth, the antenna structure 500 may achieve a great radiation frequency bandwidth.

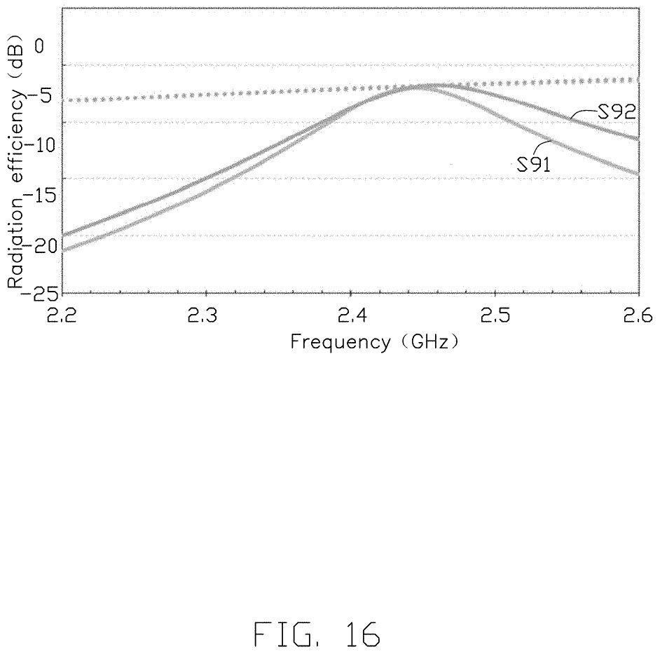

FIG. 16 is a radiation efficiency graph of the antenna structure 500. A curve S91 shows radiation efficiencies when the antenna structure 500 excluding the second radiating portion 530; a curve S92 shows radiation efficiencies when the antenna structure 500 including the second radiating portion 530. As shown in FIG. 16, it can be known that when the antenna structure 500 includes the second radiating portion 530, and the second radiating portion 530 takes part in radiation signals, the antenna structure 500 has a good radiation characteristic.

The antenna structure 500 sets the second radiating portion 530 on the appearance surface of the wearable device 600 to form the predetermined metal logo, which may improve a peculiarity and an identifiability of the wearable device 600. Meanwhile, the antenna structure 500 sets the second radiating portion 530 couples the electrical current from the first radiating portion 520 having the dielectric constants, to achieve the working frequency band of the antenna structure 500 and cover the frequency band of the Bluetooth and WiFi 2.4 GHz mode, which may improve frequency width of the antenna structure 500 and radiation efficiency of the antenna structure 500, achieving a great transmission characteristic of the wearable device 600.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An antenna structure applied in a wearable device, the antenna structure comprising:
a ceramic layer, the ceramic layer comprising a first surface and a second surface corresponding to each other;
a plastic layer, the plastic layer connected to the second surface;
a radiating portion, the radiating portion being a predetermined metal pattern, the radiating portion arranged in the first surface;
a feed portion; and
a connecting portion, the connecting portion passing through the plastic layer and electrically connected to the feed portion;
wherein the feed portion feeds an electrical current to the radiating portion to generate radiation signals in at least one radiation frequency band.

2. The antenna structure of claim 1, wherein the first surface of the ceramic layer defines a slot, the radiating portion is received in the slot and the radiating portion is exposed from the first surface.

3. The antenna structure of claim 2, wherein the slot is defined throughout from the first surface to the second surface of the ceramic layer.

4. The antenna structure of claim 1, further comprising a circuit board, wherein the circuit board is arranged on a side of the plastic layer away from the ceramic layer, the feed portion is arranged on the circuit board.

5. The antenna structure of claim 1, wherein the radiating portion is a predetermined letter shaped and has a plurality of radiating arms.

6. The antenna structure of claim 1, wherein a range of predetermined dielectric constants of the ceramic layer is 10˜40.

7. The antenna structure of claim 1, wherein the radiating portion is spaced apart from the connecting portion.

8. An antenna structure applied in a wearable device, the antenna structure comprising:
a plastic layer, the plastic layer comprising a first surface and a second surface corresponding to each other;
a first radiating portion, the first radiating portion arranged in the first surface;
a second radiating portion, the second radiating portion being a predetermined metal pattern, the second radiating portion arranged in the second surface;
a feed portion; and
a connecting portion, the connecting portion electrically connected to the feed portion and the first radiating portion;
wherein the feed portion feeds an electrical current to the first radiating portion, the first radiating portion conducts the electrical current, the second radiating portion couples the electrical current from the first radiating portion to generate radiation signals in a first radiation frequency band.

9. The antenna structure of claim 8, wherein the first radiating portion is a ceramic antenna.

10. The antenna structure of claim 9, wherein the ceramic antenna is formed by a metal radiating portion received in a ceramic layer.

11. The antenna structure of claim 9, wherein the ceramic antenna is formed by a metal radiating portion arranged on a surface of a ceramic layer.

12. The antenna structure of claim 8, wherein the second radiating portion is arranged in the second surface and exposed on the second surface of the plastic layer.

13. The antenna structure of claim 8, further comprising a circuit board, wherein the circuit board is adjacent to a side of the plastic layer arranging the first radiating portion, the feed portion is arranged on the circuit board.

14. The antenna structure of claim 13, further comprising a matching circuit, wherein the matching circuit is arranged on the circuit board and electrically connected to the feed portion, the matching circuit is configured to adjust the first radiation frequency band and a second radiation frequency band of the radiation signals generated by the first radiating portion and the second radiating portion.

15. The antenna structure of claim 9, wherein a range of predetermined dielectric constants of the second radiating portion is adjustable according to a size of the second radiating portion.

16. A wearable device, comprising:
an antenna structure comprising:
a ceramic layer, the ceramic layer comprising a first surface and a second surface corresponding to each other;
a plastic layer, the plastic layer connected to the second surface;
a radiating portion, the radiating portion being a predetermined metal pattern, the radiating portion arranged in the first surface;
a feed portion; and
a connecting portion, the connecting portion passing through the plastic layer and electrically connected to the feed portion;
wherein the feed portion feeds an electrical current to the radiating portion to generate radiation signals in at least one radiation frequency band.

17. The wearable device of claim 16, further comprising a housing, wherein the antenna structure is received in the housing.

18. A wearable device, comprising:
an antenna structure comprising:
a plastic layer, the plastic layer comprising a first surface and a second surface corresponding to each other;
a first radiating portion, the first radiating portion arranged in the first surface;
a second radiating portion, the second radiating portion being a predetermined metal pattern, the second radiating portion arranged in the second surface;
a feed portion; and
a connecting portion, the connecting portion electrically connected to the feed portion and the first radiating portion;
wherein the feed portion feeds an electrical current to the first radiating portion, the first radiating portion conducts the electrical current, the second radiating portion couples the electrical current from the first radiating portion to generate radiation signals in a first radiation frequency band.

19. The wearable device of claim 18, further comprising a housing, wherein the antenna structure is received in the housing.

20. The wearable device of claim 18, wherein the first radiating portion is a ceramic antenna.
